(19) United States
(12) Patent Application Publication
(10) Pub. No.: US 2025/0014813 A1
(43) Pub. Date: Jan. 9, 2025

(54) REACTOR, CONVERTER, AND POWER CONVERSION DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Kazuhiro INABA, Mie (JP)

(21) Appl. No.: 18/711,072

(22) PCT Filed: Oct. 27, 2022
(86) PCT No.: PCT/JP2022/040159

§ 371 Date: May 16, 2024

(30) Foreign Application Priority Data
Nov. 24, 2021 (JP) 2021-190492

(51) Int. Cl. H01F 27/40; H01F 27/24; H01F 27/28

(52) U.S. Cl. CPC H01F 27/402; H01F 27/24; H01F 27/28

(57) ABSTRACT

A reactor includes a coil, a magnetic core and a sensor for measuring a physical quantity of the reactor. The coil includes a tubular winding portion. The magnetic core includes a first end core portion, a second end core portion, a middle core portion, a first side core portion and a second side core portion. The middle core portion includes a part to be arranged inside the winding portion. The first side core portion and the second side core portion are arranged in parallel outside the winding portion to sandwich the middle core portion. The middle core portion, the first side core portion and the second side core portion connect the first end core portion and the second end core portion. A relative magnetic permeability of the second end core portion is larger than that of the first end core portion.

### TECHNICAL FIELD

The present disclosure relates to a reactor, a converter and a power conversion device.

This application claims a priority based on Japanese Patent Application No. 2021-190492 filed on Nov. 24, 2021, all the contents of which are hereby incorporated by reference.

### BACKGROUND

Constituent components of a converter to be installed in a vehicle such as a hybrid vehicle include a reactor. An in-vehicle reactor is disclosed in Patent Document 1 and 2.

Patent Document 1 discloses a reactor provided with a coil and a magnetic core obtained by combining two core pieces. A reactor shown in FIGS. 1 and 2 of Patent Document 1 is provided with a coil including two winding portions and a magnetic core including two U-shaped core pieces. This magnetic core is a so-called U-U type core. The U-U type core is configured into an annular shape by combining the U-shaped core pieces such that end surfaces thereof face each other. A reactor shown in FIGS. 5 and 6 of Patent Document 1 is provided with a coil including one winding portion and a magnetic core including two E-shaped core pieces. This magnetic core is a so-called E-E type core. The E-E type core is configured into a θ shape by combining the E-shaped core pieces such that end surfaces thereof face each other.

Patent Document 2 discloses a reactor provided with a sensor for measuring a physical quantity of the reactor.

### PRIOR ART DOCUMENT

### Patent Document

Patent Document 1: JP 2016-201509 A
Patent Document 2: JP 2016-082043 A

### SUMMARY OF THE INVENTION

A reactor of the present disclosure is provided with a coil, a magnetic core and a sensor for measuring a physical quantity of the reactor, the coil including a tubular winding portion, the magnetic core including a first end core portion, a second end core portion, a middle core portion, a first side core portion and a second side core portion, the middle core portion including a part to be arranged inside the winding portion, the first side core portion and the second side core portion being arranged in parallel outside the winding portion to sandwich the middle core portion, the middle core portion, the first side core portion and the second side core portion connecting the first end core portion and the second end core portion, a relative magnetic permeability of the second end core portion being larger than that of the first end core portion, and the sensor being arranged closer to the second end core portion than a center line between the first end core portion and the second end core portion.

A converter of the present disclosure is provided with the reactor of the present disclosure.

A power conversion device of the present disclosure is provided with the converter of the present disclosure.

### BRIEF DESCRIPTION OF THE DRAWINGS

FIG. 1 is a schematic perspective view showing a reactor according to a first embodiment.

FIG. 2 is a schematic plan view showing the reactor according to the first embodiment.

FIG. 3 is a schematic front view of the reactor according to the first embodiment when viewed from the side of a second end core portion.

FIG. 4 is a schematic plan view showing a reactor according to a second embodiment.

FIG. 5 is a schematic plan view showing a reactor according to a third embodiment.

FIG. 6 is a configuration diagram schematically showing a power supply system of a hybrid vehicle.

FIG. 7 is a circuit diagram schematically showing an example of a power conversion device provided with a converter.

FIG. 8 is a diagram showing measurement points in Analysis Example 1 of Text Example 1.

FIG. 9 is a graph showing temporal transitions of magnetic flux densities obtained in Analysis Example 1 of Text Example 1.

FIG. 10 is a diagram showing measurement points in Analysis Example 2 of Text Example 1.

FIG. 11 is a graph showing temporal transitions of magnetic flux densities obtained in Analysis Example 2 of Text Example 1.

### DETAILED DESCRIPTION TO EXECUTE THE INVENTION

### Problems to be Solved

Various sensors for measuring physical quantities of a reactor may be mounted in the reactor for a control corresponding to a state of the reactor. The sensors include, for example, a current sensor for measuring a current flowing in a coil and a temperature sensor for measuring a temperature of the coil and a temperature of a magnetic core.

The sensors may be affected by a magnetic flux leaking from the magnetic core during the operation of the reactor. The operation of the sensors may become unstable due to the leakage magnetic flux from the magnetic core. In that case, the measurement accuracy of the sensors may be degraded. Therefore, in the case of arranging the sensors in the reactor, it is desired to suppress the influence of a leakage magnetic flux on the sensors.

One object of the present disclosure is to provide a reactor capable of reducing the influence of a magnetic flux on a sensor. Another object of the present disclosure is to provide a converter provided with the above reactor. Still another object of the present disclosure is to provide a power conversion device provided with the above converter.

### Effect of the Invention

The reactor of the present disclosure can reduce the influence of a leakage magnetic flux on a sensor. Further, the converter and the power conversion device of the present disclosure easily precisely measure a physical quantity of the reactor by the sensor.

### DESCRIPTION OF EMBODIMENTS OF PRESENT DISCLOSURE

The present inventor and other researchers obtained the following knowledge as a result of an earnest study of the influence of a leakage magnetic flux on a sensor. By examining a distribution of a leakage magnetic flux of a magnetic core, the present inventor and other researchers found that the magnetic flux leaked differently depending on the shape of the magnetic core. If the magnetic core is configured into a θ shape like an E-E type, a magnetic flux easily leaks from end core portions arranged outside a coil. On the other hand, if the magnetic core is configured into an annular shape like a U-U type, a magnetic flux is relatively less likely to leak. Thus, particularly in the case of adopting the θ-shaped magnetic core, it is necessary to consider such that the sensor is least affected by a leakage magnetic flux.

To prevent the sensor from being affected by a leakage magnetic flux, it is, for example, considered to distance the sensor from the magnetic core or use a sensor provided with a magnetic shield. However, if the sensor is distanced from the magnetic core, there is a problem that an accurate measurement cannot be performed or the arrangement position of the sensor is limited. That is, a degree of freedom in laying out the sensor is reduced. Further, since the sensor provided with the magnetic shield is expensive, there is a problem of increasing cost. It is desired to reduce the influence of a leakage magnetic flux on the sensor by a simple means.

The present disclosure is based on the above knowledge. First, embodiments of the present disclosure are listed and described.
(1) A reactor according to an embodiment of the present disclosure is provided with a coil, a magnetic core and a sensor for measuring a physical quantity of the reactor, the coil including a tubular winding portion, the magnetic core including a first end core portion, a second end core portion, a middle core portion, a first side core portion and a second side core portion, the middle core portion including a part to be arranged inside the winding portion, the first side core portion and the second side core portion being arranged in parallel outside the winding portion to sandwich the middle core portion, the middle core portion, the first side core portion and the second side core portion connecting the first end core portion and the second end core portion, a relative magnetic permeability of the second end core portion being larger than that of the first end core portion, and the sensor being arranged closer to the second end core portion than a center line between the first end core portion and the second end core portion.

The reactor of the present disclosure can reduce the influence of a leakage magnetic flux on the sensor. In the reactor of the present disclosure, the sensor is arranged on the side of the second end core portion. Since the relative magnetic permeability of the second end core portion is larger than that of the first end core portion, the magnetic flux leaks less from the second side core portion than from the first end core portion. In the reactor of the present disclosure, by arranging the sensor on the side of the second end core portion, the influence of the leakage magnetic flux on the sensor is reduced as compared to the case where the sensor is arranged on the side of the first end core portion. Thus, the sensor is hardly affected by the leakage magnetic flux, wherefore a physical quantity of the reactor is easily precisely measured.
(2) In the reactor of (1) described above, the relative magnetic permeability of the first end core portion may be 5 or more and 50 or less.

As the relative magnetic permeability of the first end core portion decreases, the leakage magnetic flux from the first end core portion increases. In the configuration of (2) described above, there is a large advantage in arranging the sensor on the side of the second end core portion.
(3) In the reactor of (2) described above, the relative magnetic permeability of the second end core portion may be 100 or more and 500 or less.

Since the configuration of (3) described above can reduce the leakage magnetic flux from the second end core portion, the influence of the leakage magnetic flux on the sensor can be suppressed.
(4) In the reactor of any one of (1) to (3) described above, a distance from the second end core portion to the sensor may be within 50 mm.

In the configuration of (4) described above, the sensor and the second end core portion are close. Since the sensor can be arranged close to the reactor in the configuration of (4) described above, a degree of freedom in laying out the sensor can be enhanced.
(5) In the reactor of any one of (1) to (4) described above, the sensor may be arranged at a position where a density change width of a magnetic field leaking from the magnetic core is 2.0 mT or less when the reactor is operated under first operation conditions, and the first operation conditions may include an input voltage of 200 V, a post-boosting voltage of 400 V, a switching frequency of 20 kHz and a superimposed current of 100 A.

As the leakage magnetic flux changes more, the sensor is more strongly affected by the leakage magnetic flux. If the sensor is arranged at a position where the change width of the leakage magnetic flux destiny is 2.0 mT or less, the sensor is hardly affected by the leakage magnetic flux.
(6) In the reactor of (5) described above, a maximum value of the magnetic field density may be 6.0 mT or less.

As the leakage magnetic flux density increases, the sensor is more easily affected by the leakage magnetic flux. If the sensor is arranged at a position where the maximum value of the leakage magnetic flux density is 6.0 mT or less, the sensor is less affected by the leakage magnetic flux.
(7) In the reactor of any one of (1) to (6) described above, the sensor may be arranged in a region overlapping the second end core portion in a plan view of the reactor.

The configuration of (7) described above has a high degree of freedom in laying out the sensor.
(8) In the reactor of any one of (1) to (7) described above, the sensor may be arranged in a region on an extension of the middle core portion in a plan view of the reactor.

The configuration of (8) described above has a high degree of freedom in laying out the sensor.
(9) In the reactor of any one of (1) to (8) described above, a circuit board may be provided which controls a current flowing in the coil, the sensor may be a current sensor, and the current sensor may be provided on the circuit board.

The circuit board for controlling the current flowing in the coil may be disposed around the reactor. In the configuration of (9) described above, the current flowing in the coil can be measured by the current sensor provided on the circuit board.
(10) In the reactor of any one of (1) to (8) described above, the sensor may be a temperature sensor, and the temperature sensor may be fixed to the second end core portion.

In the configuration of (10) described above, a temperature of the second end core portion can be measured by the temperature sensor.
(11) In the reactor of any one of (1) to (10) described above, the first end core portion may be constituted by a compact of a composite material in which a soft magnetic powder is dispersed in a resin, and the second end core portion may be constituted by a powder compact of a raw powder containing a soft magnetic powder.

Generally, a relative magnetic permeability of a compact of a composite material is smaller than that of a powder compact. In the configuration of (11) described above, the first end core portion is constituted by the compact of the composite material and the second end core portion is constituted by the powder compact. Thus, the relative magnetic permeability of the second end core portion is larger than that of the first end core portion.
(12) A converter according to an embodiment of the present disclosure is provided with the reactor of any one of (1) to (11) described above.

The converter of the present disclosure easily precisely measures a physical quantity of the reactor by the sensor since being provided with the reactor of the present disclosure.
(13) A power conversion device according to an embodiment of the present disclosure is provided with the converter of (12) described above.

The power conversion device of the present disclosure easily precisely measures a physical quantity of the reactor by the sensor since being provided with the converter of the present disclosure.

### DETAILS OF EMBODIMENTS OF PRESENT DISCLOSURE

Specific embodiments of the present disclosure are described in detail below with reference to the drawings. The same reference signs in figures denote the same components. Note that the present invention is not limited to these illustrations, but is represented by claims and intended to include all changes in the scope of claims and in the meaning and scope of equivalents.

### First Embodiment

### [Reactor]

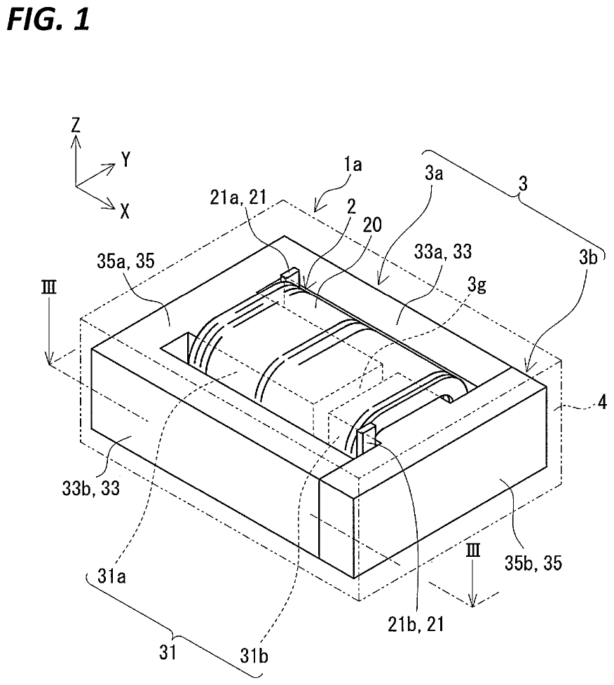

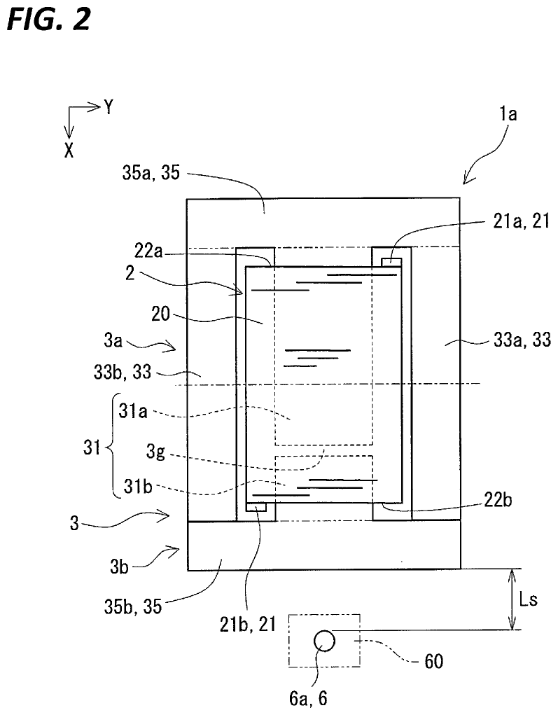

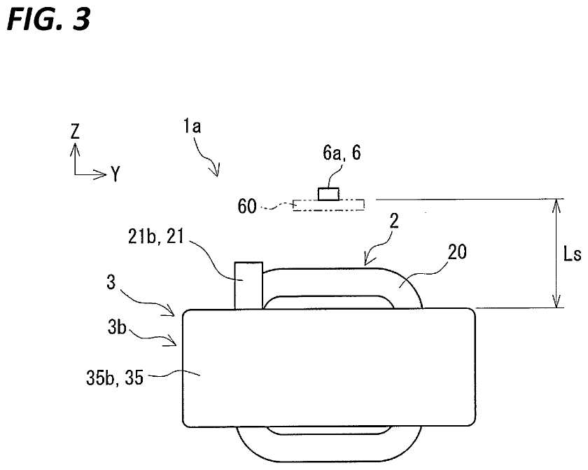

A reactor 1a of a first embodiment is described with reference to FIGS. 1 to 3. The reactor 1a is provided with a coil 2 and a magnetic core 3. The coil 2 includes a winding portion 20. The magnetic core 3 includes a first end core portion 35a and a second end core portion 35b. Further, the reactor 1a is provided with a sensor 6 (see FIGS. 2 and 3).

One of features of the reactor 1a of the first embodiment is to satisfy the following requirements (a), (b).
(a) A relative magnetic permeability of the second end core portion 35b is larger than that of the first end core portion 35a.
(b) As shown in FIG. 2, the sensor 6 is arranged closer to the second end core portion 35b than a center line between the first and second end core portions 35a, 35b.

By arranging the sensor 6 on the side of the second end core portion 35b, the reactor 1a can reduce the influence of a leakage magnetic flux on the sensor 6 as compared to the case where the sensor 6 is arranged on the side of the first end core portion 35a. Hereinafter, the configuration of the reactor 1a is described in detail.

### <Coil>

As shown in FIGS. 1 and 2, the coil 2 includes the tubular winding portion 20. The winding portion 20 is a part formed by spirally winding a winding wire. A known winding wire can be used as the winding wire. The winding wire is a coated rectangular wire including a conductor wire and an insulation coating covering the conductor wire. The conductor wire is a rectangular wire made of copper. The insulation coating is made of enamel. In this embodiment, one winding portion 20 is provided. The number of turns of the winding portion 20 is, for example, 10 or more and 60 or less, further 20 or more or 50 or less. In this embodiment, the coil 2 is an edgewise coil formed by winding the coated rectangular wire in an edgewise manner.

The winding portion 20 has a tubular shape. The winding portion 20 may have a polygonal tube shape or a circular tube shape. The polygonal tube shape has a polygonal contour shape of an end surface when viewed from an axial direction of the winding portion 20. The polygonal shapes include, for example, quadrilateral shapes, hexagonal shapes and octagonal shapes. The quadrilateral shapes include rectangular shapes. The rectangular shapes include square shapes. The circular tube shape has a circular contour shape of the end surface. The circular shapes include not only true circular shapes, but also elliptical shapes. In this embodiment, the winding portion 20 has a rectangular tube shape.

The winding portion 20 has a first end surface 22a and a second end surface 22b. The first end surface 22a is an end surface on one side in the axial direction of the winding portion 20. The second end surface 22b is an end surface on the other side in the axial direction of the winding portion 20.

The coil 2 includes end portions 21. The end portions 21 are parts of the winding wire pulled out from both end parts of the winding portion 20. The end portions 21 include a first end portion 21a and a second end portion 21b. The first end portion 21a is pulled out to an outer peripheral side of the winding portion 20 from one end part of the winding portion 20. The second end portion 21b is pulled out to the outer peripheral side of the winding portion 20 from the other end part of the winding portion 20. In the first and second end portions 21a, 21b, the insulation coating is stripped to expose the conductor wire. An unillustrated busbar is, for example, connected to the first and second end portions 21a, 21b. The coil 2 is connected to an unillustrated external device via the busbar. The external device is a power supply for supplying power to the coil 2 or the like.

### <Magnetic Core>

As shown in FIGS. 1 and 2, the magnetic core 3 includes a middle core portion 31, side core portions 33 and end core portions 35. The magnetic core 3 is configured into a θ shape as a whole in a plan view. In this embodiment, the magnetic core 3 includes a first core 3a and a second core 3b. The magnetic core 3 is configured by combining the first and second cores 3a, 3b. The first and second cores 3a, 3b are combined in the axial direction of the winding portion 20. In FIG. 2, boundaries between the middle core portion 31 and the end core portions 35 and boundaries between the side core portions 33 and the end core portions 35 are shown by two-dot chain lines. The first and second cores 3a, 3b are described in detail later.

In the following description, a direction along the axial direction of the winding portion 20 is an X direction. A parallel direction of the middle core portion 31 and the side core portions 33 is a Y direction. The Y direction is orthogonal to the X direction. A direction orthogonal to the both X and Y directions is a Z direction. In the Z direction, a side where the end portions 21 of the coil 2 are located is referred to as an upper side, and an opposite side thereof is referred to as a lower side. The plan view described above shows a state when the reactor 1a is viewed from above, i.e. from the Z direction.

The magnetic core 3 has a θ shape when viewed from the Z direction as shown in FIG. 2. If the coil 2 is energized, a θ-shaped closed magnetic path is formed in the magnetic core 3. In this closed magnetic path, a magnetic flux generated by the coil 2 returns from the middle core portion 31 to the middle core portion 31 through one end core portion 35, the respective side core portions 33 and the other end core portion 35.

### (End Core Portions)

The end core portions 35 are parts to be arranged outside the winding portion 20. Two end core portions 35 are provided. The end core portions 35 include the first end core portion 35a and the second end core portion 35b. The first and second end core portions 35a, 35b are arranged apart in the X direction. The first end core portion 35a is located on one side in the X direction. The first end core portion 35a faces the first end surface 22a of the winding portion 20. The second end core portion 35b is located on the other side in the X direction. The second end core portion 35b faces the second end surface 22b of the winding portion 20.

The shape of each of the first and second end core portions 35a, 35b is not particularly limited if the first and second end core portions 35a, 35b are shaped to form a predetermined magnetic path. In this embodiment, each of the first and second end core portions 35a, 35b has a substantially rectangular parallelepiped shape.

### (Middle Core Portion)

The middle core portion 31 includes a part to be arranged inside the winding portion 20. One middle core portion 31 is provided. The middle core portion 31 is a part to be sandwiched by first and second end core portions 35a, 35b, out of the magnetic core 3. The middle core portion 31 extends along the X direction. An axial direction of the middle core portion 31 coincides with the axial direction of the winding portion 20. In this embodiment, both end parts of the middle core portion 31 project from both end surfaces of the winding portion 20. These projecting parts are also parts of the middle core portion 31.

An end part on the one side in the X direction of the middle core portion 31 is connected to the first end core portion 35a. An end part on the other side in the X direction of the middle core portion 31 is connected to the second end core portion 35b.

The shape of the middle core portion 31 is not particularly limited if this shape corresponds to the inner shape of the winding portion 20. In this embodiment, the middle core portion 31 has a substantially rectangular parallelepiped shape. When viewed from the X direction, corner parts of the outer peripheral surface of the middle core portion 31 may be rounded along the inner peripheral surface of the winding portion 20.

The middle core portion 31 may or may not be divided in the X direction. In this embodiment, the middle core portion 31 is divided in the X direction and includes a first middle core portion 31a and a second middle core portion 31b. An end surface of the first middle core portion 31a and that of the second middle core portion 31b are facing each other in the X direction. The first middle core portion 31a is located on the one side in the X direction where the first end core portion 35a is arranged. The one side in the X direction is an upper side in FIG. 2. An end part of the first middle core portion 31a is connected to the first end core portion 35a. The second middle core portion 31b is located on the other side in the X direction where the second end core portion 35b is arranged. The other side in the X direction is a lower side in FIG. 2. An end part of the second middle core portion 31b is connected to the second end core portion 35b.

A length of each of the first and second middle core portions 31a, 31b may be set as appropriate. The length mentioned here means a length along the X direction. In this embodiment, the first middle core portion 31a is longer than the second middle core portion 31b. Unlike this embodiment, the first middle core portion 31a may be shorter than the second middle core portion 31b. The first and second middle core portions 31a, 31b may have the same length.

In this embodiment, the middle core portion 31 includes a gap portion 3g. The gap portion 3g is provided between the first and second middle core portions 31a, 31b. The gap portion 3g is located inside the winding portion 20. By locating the gap portion 3g inside the winding portion 20, a leakage magnetic flux from the gap portion 3g is reduced as compared to the case where the gap portion 3g is located outside the winding portion 20. Thus, a loss due to the leakage magnetic flux from the gap portion 3g can be reduced. A length along the X direction of the gap portion 3g may be set as appropriate to obtain a predetermined inductance. The length of the gap portion 3g is, for example, 0.1 mm or more and 2 mm or less, 0.3 mm or more and 1.5 mm or less, further 0.5 mm or more and 1 mm or less. The gap portion 3g may be an air gap. A nonmagnetic body made of resin or ceramic may be arranged in the gap portion 3g. Unlike this embodiment, the gap portion 3g may not be present. In this case, the end surface of the first middle core portion 31a and that of the second middle core portion 31b are in contact with each other and there is substantially no clearance between the first and second middle core portions 31a, 31b.

### (Side Core Portions)

The side core portions 33 are parts to be arranged outside the winding portion 20. Two side core portions 33 are provided. The side core portions 33 includes a first side core portion 33a and a second side core portion 33b. The first and second side core portions 33a, 33b are arranged in parallel to sandwich the middle core portion 31. That is, the middle core portion 31 is arranged between the first and second side core portions 33a, 33b. Each of the first and second side core portions 33a, 33b extends in the X direction. An axial direction of each of the first and second side core portions 33a, 33b is parallel to that of the middle core portion 31. The first and second side core portions 33a, 33b are arranged at an interval in the Y direction. The middle core portion 31, the first side core portion 33a and the second side core portion 33b connect the first and second end core portions 35a, 35b.

The first side core portion 33a is located on one side in the Y direction. The first side core portion 33a faces a side surface on the one side in the Y direction, out of the outer peripheral surface of the winding portion 20. The one side in the Y direction is a right side in FIG. 2. An end part on the one side in the X direction of the first side core portion 33a is connected to the first end core portion 35a. An end part on the other side in the X direction of the first side core portion 33a is connected to the second end core portion 35b.

The second side core portion 33b is located on the other side in the Y direction. The second side core portion 33b faces a side surface on the other side in the Y direction, out of the outer peripheral surface of the winding portion 20. The other side in the Y direction is a left side in FIG. 2. An end part on the one side in the X direction of the second side core portion 33b is connected to the first end core portion 35a. An end part on the other side in the X direction of the second side core portion 33b is connected to the second end core portion 35b.

Each of the first and second side core portions 33a, 33b may have such a length as to connect the first and second end core portions 35a, 35b. The shape of each of the first and second side core portions 33a, 33b is not particularly limited. In this embodiment, each of the first and second side core portions 33a, 33b has a substantially rectangular parallelepiped shape. Cross-sectional areas of the respective first and second side core portions 33a, 33b may be equal or different. In this embodiment, the cross-sectional area of the first side core portion 33a and that of the second side core portion 33b are equal. Further, in this embodiment, the sum of the cross-sectional area of the first side core portion 33a and that of the second side core portion 33b is equal to the cross-sectional area of the middle core portion 31. The cross-sectional area mentioned here means an area of a cross-section orthogonal to the X direction.

At least one of the first and second side core portions 33a, 33b may or may not be divided in the X direction. In this embodiment, the first and second side core portions 33a, 33b are not divided.

### <First Core, Second Core>

The shapes of the first and second cores 3a, 3b can be selected from various combinations. In this embodiment, the magnetic core 3 is of an E-T type by combining the E-shaped first core 3a and the T-shaped second core 3b as shown in FIGS. 1 and 2.

### <First Core>

The first core 3a includes, for example, the first end core portion 35a, at least a part of the first middle core portion 31a and at least a part of each of the first and second side core portions 33a, 33b. In this embodiment, as shown in FIG. 2, the first core 3a includes the first end core portion 35a, the first middle core portion 31a, which is a part of the middle core portion 31, the entire first side core portion 33a and the entire second side core portion 33b. The first end core portion 35a, the first middle core portion 31a, the first side core portion 33a and the second side core portion 33b are integrally formed. Since the first core 3a is an integrally formed body, each core portion constituting the first core 3a is made of the same material. That is, each core portion constituting the first core 3a has substantially the same magnetic properties and mechanical properties. The first middle core portion 31a extends in the X direction from a middle part in the Y direction of the first end core portion 35a toward the second middle core portion 31b. The respective first and second side core portions 33a, 33b extend in the X direction from both end parts in the Y direction of the first end core portion 35a toward the second end core portion 35b. The first core 3a is E-shaped when viewed from the Z direction.

### <Second Core>

In this embodiment, the second core 3b includes the second end core portion 35b and the second middle core portion 31b, which is the remaining part of the middle core portion 31. The second core 3b does not include the first and second side core portions 33a, 33b. The second end core portion 35b and the second middle core portion 31b are integrally formed. Since the second core 3b is an integrally formed body, each core portion constituting the second core 3b is made of the same material. That is, each core portion constituting the second core 3b has substantially the same magnetic properties and mechanical properties. The second middle core portion 31b extends in the X direction from a middle part in the Y direction of the second end core portion 35b toward the first middle core portion 31a. The second core 3b is T-shaped when viewed from the Z direction.

In this embodiment, the magnetic core 3 is composed of two pieces including the first and second cores 3a, 3b. That is, the division number of the magnetic core 3 is two. The division number of the magnetic core 3 and positions where the magnetic core 3 is divided are not particularly limited. The magnetic core 3 may be composed of three or more pieces. For example, the first end core portion 35a, the second end core portion 35b, the first middle core portion 31a, the second middle core portion 31b and the first side core portion 33a and the second side core portion 33b may be respectively individually configured, and the magnetic core 3 may be configured by combining these. If the magnetic core 3 is composed of the first and second cores 3a, 3b as in this embodiment, the magnetic core 3 is easily assembled since there are only two core pieces to be combined.

### (Relationship of Relative Magnetic Permeability of First End Core Portion and Relative Magnetic Permeability of Second End Core Portion)

A relative magnetic permeability of the second end core portion 35b is larger than that of the first end core portion 35a. That is, a relative magnetic permeability of the second core 3b is larger than that of the first core 3a. The relative magnetic permeability of each of the first and second cores 3a, 3b may be set as appropriate to obtain a predetermined inductance after satisfying the above relationship. The relative magnetic permeability of the first end core portion 35a is, for example, 5 or more and 50 or less. The relative magnetic permeability of the first end core portion 35a may be 10 or more and 45 or less, further 15 or more and 40 or less. The relative magnetic permeability of the second end core portion 35b is, for example, 50 or more and 500 or less. The relative magnetic permeability of the second end core portion 35b may be 100 or more and 500 or less, 100 or more and 450 or less, further 150 or more and 400 or less. Relative magnetic permeabilities of the other core portions do not particularly matter if the relative magnetic permeability of the second end core portion 35b is larger than that of the first end core portion 35a.

A difference between the relative magnetic permeability of the second end core portion 35b and that of the first end core portion 35a is, for example, 50 or more. An upper limit of the relative magnetic permeability difference is practically, for example, about 500. The relative magnetic permeability difference may be 50 or more and 500 or less, further 100 or more and 400 or less.

The relative magnetic permeability can be obtained as follows. A ring-shaped measurement sample is cut out from each of the first and second end core portions 35a, 35b. Wire winding of 300 winds on a primary side and 20 winds on a secondary side is applied to each measurement sample. A B-H initial magnetization curve is measured in a range of H=0 (Oe) or more and 100 (Oe) or less, and a maximum value of this B-H initial magnetization curve is obtained. This maximum value is set as a relative magnetic permeability. The magnetization curve mentioned here is a so-called direct-current magnetization curve.

### (Material of End Core Portions)

The first and second end core portions 35a, 35b are constituted by compacts of soft magnetic materials. The compacts are, for example, powder compacts or compacts of composite materials. The first and second end core portions 35a, 35b are constituted by compacts made of mutually different materials. The mutually different materials mean, of course, a case where materials of individual constituent elements are different in the respective compacts constituting the first and second end core portions 35a, 35b and also a case where contents of constituent elements are different even if materials of individual constituent elements are the same. For example, even if the first and second end core portions 35a, 35b are constituted by powder compacts, these are made of mutually different materials if at least one of a material and a content of a soft magnetic powder constituting the powder compact is different. Further, even if the first and second end core portions 35a, 35b are constituted by compacts of composite materials, these are made of mutually different materials if at least one of a material and a content of a soft magnetic powder constituting the composite material is different.

The powder compact is formed by compression-forming a raw material powder containing a soft magnetic powder. The powder compact has a higher content of the soft magnetic powder than the compact of the composite material. Thus, the powder compact has higher magnetic properties than the compact of the composite material. The magnetic properties include, for example, a relative magnetic permeability and a saturated magnetic flux density. The powder compact may contain, for example, at least one of a binder resin and a molding aid. A content of the soft magnetic powder in the powder compact is, for example, 85% by volume or more and 99.99% by volume or less when the powder compact is 100% by volume.

In the compact of the composite material, the soft magnetic powder is dispersed in a resin. The compact of the composite material is obtained by filling a fluid raw material, in which the soft magnetic powder is dispersed in the uncured resin, into a mold and solidifying the resin. The compact of the composite material can easily adjust a content of the soft magnetic powder. Thus, the compact of the composite material easily adjusts the magnetic properties. A content of the soft magnetic powder in the compact of the composite material is, for example, 20% by volume or more and 80% by volume or less when the composite material is 100% by volume.

Particles constituting the soft magnetic powder are at least one type of particles of soft magnetic metal, coated particles including insulation coatings on the outer peripheries of particles of soft magnetic metal and particles of soft magnetic nonmetal. The soft magnetic metal is, for example, pure iron or an iron-based alloy. The iron-based alloy is, for example, a Fe (iron)-Si (silicon) alloy or a Fe—Ni (nickel) alloy. The insulation coating is, for example, a phosphate. The soft magnetic nonmetal is, for example, ferrite.

The resin of the compact of the composite material may be a thermosetting resin or a thermoplastic resin. The thermosetting resin is, for example, an unsaturated polyester resin, an epoxy resin, a urethane resin or a silicone resin. The thermoplastic resin is, for example, a polyphenylene sulfide resin, a polytetrafluoroethylene resin, a liquid crystal polymer, a polyamide resin, a polybutylene terephthalate resin or an acrylonitrile-butadiene-styrene resin. The polyamide resin is, for example, nylon 6, nylon 66 or nylon 9T. Besides, the resin of the compact of the composite material may be, for example, a BMC (Bulk Molding Compound) in which calcium carbonate and glass fibers are mixed in an unsaturated polyester, a millable-type silicone rubber or a millable-type urethane rubber.

The compact of the composite material may contain a filler in addition to the soft magnetic powder and the resin. The filler is, for example, a ceramic filler made of alumina or silica. By containing the filler, the compact of the composite material can enhance heat dissipation. A content of the filler is, for example, 0.2% by mass or more and 20% by mass or less, further 0.3% by mass or more and 15% by mass or less, or 0.5% by mass or more and 10% by mass or less when the compact of the composite material is 100% by volume.

A content of the soft magnetic powder in the powder compact or the compact of the composite material is assumed to be equivalent to an area ratio of the soft magnetic powder in a cross-section of the compact. The content of the soft magnetic powder is obtained as follows. A cross-section of the compact is observed by a scanning electron microscope (SEM) and observation images are obtained. A magnification of the SEM is, for example, set to 200× or more and 500× or less. The number of the obtained observation images is 10 or more. A total area of the observation image is set to 0.1 cm² or more. One observation image may be obtained for one cross-section or a plurality of observation images may be obtained for one cross-section. An image processing is applied to each obtained observation image to extract the contours of the particles of the soft magnetic powder. The image processing is, for example, a binarization processing. A total area of the particles of the soft magnetic powder in each observation image is calculated, and an area ratio of the particles of the soft magnetic powder in each observation image is obtained. An average value of the area ratios in all the observation images is assumed as the content of the soft magnetic powder.

In this embodiment, the first core 3a including the first end core portion 35a is the compact of the composite material, and the second core 3b including the second end core portion 35b is the powder compact. By constituting the first core 3a by the compact of the composite material and constituting the second core 3b by the powder compact, the magnetic properties of the entire magnetic core 3 can be adjusted. Further, if the first end core portion 35a is constituted by the compact of the composite material and the second end core portion 35b is constituted by the powder compact, the relative magnetic permeability of each of the first and second end core portions 35a, 35b easily satisfies the above relationship. In this embodiment, the relative magnetic permeability of the first end core portion 35a is about 20 or more and 30 or less, and the relative magnetic permeability of the second end core portion 35b is about 150 or more and 250 or less. A difference between the relative magnetic permeability of the second end core portion 35b and that of the first end core portion 35a is about 120 or more and 230 or less.

### <Sensor>

The sensor 6 is an element for measuring a physical quantity of the reactor 1a. Physical quantities mentioned here are various physical quantities produced in and around the constituent members of the reactor 1a during the operation of the reactor 1a. The constituent members are, for example, the coil 2 and the magnetic core 3. Typical physical quantities are a current and a temperature.

The sensor 6 is, for example, at least one of a current sensor and a temperature sensor. The current sensor is, for example, a Hall-type current sensor using a Hall element, a shunt resistance-type current sensor using a shut resistance or a magnetoresistive current sensor using a magnetoresistive element. The temperature sensor is, for example, a thermocouple, a thermistor or a temperature measuring resistor. In this embodiment, the sensor 6 is a current sensor 6a. The current sensor 6a is a Hall-type current sensor. The current sensor 6a is provided on a circuit board 60 to be described later.

### <Circuit Board>

As shown in FIG. 2, the reactor 1a is provided with the circuit board 60 for controlling a current flowing in the coil 2. The circuit board 60 is provided with the current sensor 6a. In this embodiment, the circuit board 60 is arranged above the reactor 1a as shown in FIG. 3. The circuit board 60 is, for example, supported on a case for storing the reactor 1a. The case is not shown. The circuit board 60 is connected to the end parts 21 of the coil 2 via the unillustrated busbar. A current supplied to the coil 2 from an unillustrated power supply flows in the circuit board 60. The current sensor 6a measures the current flowing in the coil 2 by measuring the current flowing in the circuit board 60. The current flowing in the coil 2 can also be measured by this current sensor by mounting the current sensor on the coil 2.

### (Position of Sensor)

In a plan view of the reactor 1a, the sensor 6 is arranged closer to the second end core portion 35b than the center line between the first and second end core portions 35a, 35b as shown in FIG. 2. That is, the sensor 6 is arranged at a position closer to the second end core portion 35b than the first end core portion 35a. The center line between the first and second end core portions 35a, 35b is a line bisecting a space between the first and second end core portions 35a, 35b facing each other in the X-direction in the plane view. This bisector passes through a center position in the X-direction of the middle core portion 31. The bisector passes through a center position in the X-direction of each of the first and second side core portions 33a, 33b.

A leakage magnetic flux is generated from the magnetic core 3 during the operation of the reactor 1a. The sensor 6 is affected by the leakage magnetic flux from the magnetic core 3. As is clear from test examples to be described later, more magnetic flux leaks from the end core portions 35, particularly the first end core portion 35a having a small relative magnetic permeability, if the magnetic core 3 has a θ shape. Thus, if the sensor 6 is arranged near the second end core portion 35b having a large relative magnetic permeability, the influence of the leakage magnetic flux on the sensor 6 is small.

A distance Ls from the second end core portion 35b to the sensor 6 is, for example, within 50 mm. The distance Ls is a shortest distance between the second end core portion 35b and the sensor 6. The shortest distance mentioned here is a shortest distance, out of linear distances from the surface of the second end core portion 35b to the surface of the sensor 6 in a three-dimensional orthogonal coordinate system. The distance Ls may be within 45 mm, further within 40 mm.

From the perspective of reducing the influence of the leakage magnetic flux on the sensor 6, the sensor 6 may be arranged at a position where a density change width ΔB of the magnetic flux leaking from the magnetic core 3 is 2.0 mT or less. The change width ΔB of the magnetic flux density mentioned here is a change width of the magnetic flux density at the position of the sensor 6 when the reactor 1a is operated under first operation conditions. The change width ΔB is assumed as a difference between a maximum value and a minimum value of a Z-direction component of the magnetic flux density. The change width ΔB may be 1.9 mT or less. A lower limit of the change width ΔB is, for example, 0.1 mT. The change width ΔB may be 0.1 mT or more and 2.0 mT or less, further 0.2 mT or more and 1.9 mT or less. The first operation conditions include an input voltage of 200 V, a post-boosting voltage of 400 V, a switching frequency of 20 kHz and a superimposed current of 100 A.

Further, a maximum value Bmax of the magnetic flux density may be 6.0 mT or less. The maximum value Bmax of the magnetic flux density mentioned here is a maximum value of the magnetic flux density at the position of the sensor 6 when the reactor 1a is operated under the first operation conditions. The maximum value Bmax is a maximum value of the Z-direction component of the magnetic flux density. The maximum value Bmax may be 5.9 mT or less. A lower limit of the maximum value Bmax is, for example, 0.1 mT. The maximum value Bmax may be 0.1 mT or more and 6.0 mT or less, further 0.1 mT or more and 5.9 mT or less or 0.2 mT or more and 5.8 mT or less.

In the plan view of the reactor 1a, the sensor 6 may be arranged in a region overlapping the second end core portion 35b. The region overlapping the second end core portion 35b includes the upper surface of the second end core portion 35b and a space above the upper surface of the second end core portion 35b. The sensor 6 may be arranged on the upper surface of the second end core portion 35b or may be arranged in a space apart from and above the upper surface of the second end core portion 35b. Further, the sensor 6 may be arranged in a region on an extension of the middle core portion 31. The arrangement in the region on the extension of the middle core portion 31 means that both side edges of the middle core portion 31 are extended in the X-direction and the sensor 6 is arranged to overlap a region sandwiched by the both extended side edges. The position in the Z direction of the sensor 6 may be within a Z-direction dimension range of the magnetic core 3 or may be above the upper surface of the second end core portion 35b.

### Miscellaneous

The reactor 1a is provided with a resin molded member 4 as another component. The resin molded member 4 is shown by two-dot chain lines in FIG. 1. The resin molded member 4 is not shown in FIGS. 2 and 3.

### (Resin Molded Member)

The resin molded member 4 covers at least a part of the outer peripheral surface of the magnetic core 3. The resin molded member 4 integrates the combined first and second cores 3a, 3b. Further, the resin molded member 4 integrates the coil 2 and the magnetic core 3. In this embodiment, the resin molded member 4 is filled also between the inner peripheral surface of the winding portion 20 and the middle core portion 31. Thus, the coil 2 is held positioned with respect to the magnetic core 3 by the resin molded member 4. Further, electrical insulation between the coil 2 and the magnetic core 3 is ensured by the resin molded member 4. A resin similar to the resin of the aforementioned compact of the composite material can be, for example, used as a resin for constituting the resin molded member 4. The resin molded member 4 may cover the outer peripheral surface of the winding portion 20. The resin molded member 4 may be formed to expose at least one of the upper and lower surfaces of the winding portion 20.

In this embodiment, the resin of the resin molded member 4 is also filled into the gap portion 3g through between the inner peripheral surface of the winding portion 20 and the middle core portion 31. The gap portion 3g is constituted by the resin of the resin molded member 4.

### (Holding Members)

The reactor 1a may be provided with unillustrated holding members as other components. The holding members are respectively arranged between the first end surface 22a of the winding portion 20 and the first end core portion 35a and between the second end surface 22b of the winding portion 20 and the second end core portion 35b. The holding members determine relative positions of the coil 2 and the magnetic core 3. Further, the holding members ensure electrical insulation between the coil 2 and the magnetic core 3. The holding members can be, for example, made of a resin similar to the resin of the aforementioned compact of the composite material.

### Functions and Effects of First Embodiment

The reactor 1a of the first embodiment can reduce the influence of a leakage magnetic flux on the sensor 6. The reason for that is that the sensor 6 is arranged on the side of the second end core portion 35b. Since the relative magnetic permeability of the second end core portion 35b is larger than that of the first end core portion 35a in the reactor 1a, the magnetic flux leaks less from the second end core portion 35b than from the first end core portion 35a. Thus, in the reactor 1a, the influence of the leakage magnetic flux on the sensor 6 is smaller as compared to the case where the sensor 6 is arranged on the side of the first end core portion 35a by arranging the sensor 6 on the side of the second end core portion 35b. Since the sensor 6 is hardly affected by the leakage magnetic flux, the physical quantities of the reactor 1a are easily precisely measured.

As the relative magnetic permeability of the first end core portion 35a decreases, the leakage magnetic flux from the first end core portion 35a increases. Thus, if the relative magnetic permeability of the first end core portion 35a is 5 or more and 50 or less, there is a large advantage in arranging the sensor 6 on the side of the second end core portion 35b. Further, if the relative magnetic permeability of the second end core portion 35b is 100 or more and 500 or less, the leakage magnetic flux from the second end core portion 35b is reduced. Thus, the influence of the leakage magnetic flux on the sensor 6 is effectively suppressed.

By arranging the sensor 6 at a position where the change width Δ of the density of the leakage magnetic flux is 2.0 mT or less when the reactor 1a is operated under the above first operation conditions, the sensor 6 is hardly affected by the leakage magnetic flux. Further, if the sensor 6 is arranged at a position where the maximum value Bmax of the leakage magnetic flux density is 6.0 mT or less, the sensor 6 is even less affected by the leakage magnetic flux.

If the distance Ls from the second end core portion 35b to the sensor 6 is within 50 mm, the sensor 6 can be arranged close to the reactor 1a, wherefore a degree of freedom in laying out the sensor 6 can be enhanced.

The sensor 6 may be arranged in the region overlapping the second end core portion 35b. If the sensor 6 is arranged in the region overlapping the second end core portion 35b, the space above the upper surface of the second end core portion 35b can be effectively utilized. A planar installation space of the reactor 1a including the sensor 6 is smaller as compared to the case where the sensor 6 is arranged in a region not overlapping the second end core portion 35b. The sensor 6 may be arranged in the region on the extension of the middle core portion 31. This region on the extension is a region where the leakage magnetic flux is easily generated as compared to a position deviated in the Y direction from the region on the extension as is clear from the test examples to be described later. However, even in the region on the extension, the influence of the leakage magnetic flux is relatively small on the side of the second end core portion 35b. Moreover, the sensor 6 can be arranged at a well-balanced position in the Y direction of the reactor 1a.

### Second Embodiment

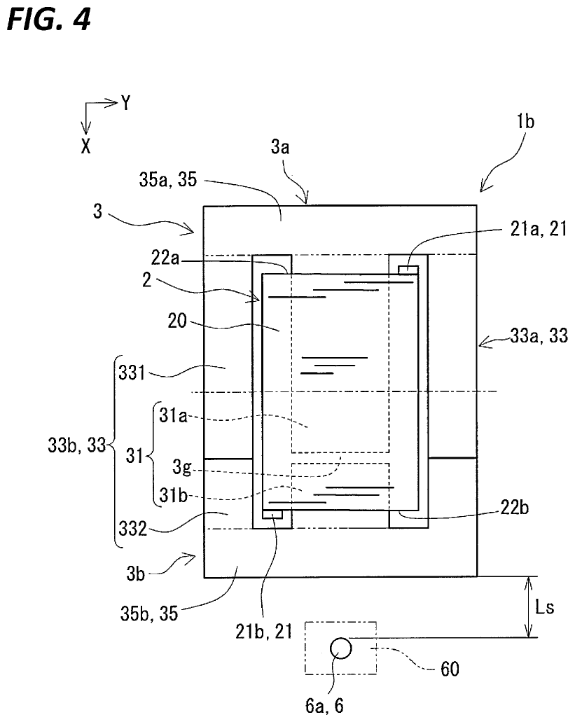

A reactor 1b of a second embodiment is described with reference to FIG. 4. The reactor 1b of the second embodiment differs from the reactor 1a of the first embodiment in that a magnetic core 3 is of an E-E type. The following description is centered on points of difference from the first embodiment. Components similar to those of the first embodiment are denoted by the same reference signs and not described. The resin molded member 4 described in the first embodiment is not shown in FIG. 4.

### <Magnetic Core>

The magnetic core 3 is configured by combining a first core 3a and a second core 3b in the X direction as in the first embodiment. The magnetic core 3 has a θ shape when viewed from the Z direction as shown in FIG. 4.

In the second embodiment, each of first and second side core portions 33a, 33b is divided in the X direction. Each of first and second side core portions 33a, 33b includes a first part 331 and a second part 332. The first part 331 is located on one side in the X direction. An end part of the first part 331 is connected to a first end core portion 35a. The second part 332 is located on the other side in the X direction. An end part of the second part 332 is connected to a second end core portion 35b.

An end surface of the first part 331 and that of the second part 332 are in contact with each other. A length of each of the first and second parts 331, 332 may be set as appropriate. The length mentioned here means a length along the X direction. In FIG. 4, the first part 331 is longer than the second part 332. The first part 331 may be shorter than the second part 332. The length of the first part 331 and that of the second part 332 may be equal.

The first core 3a includes the first end core portion 35a, a first middle core portion 31a and the first parts 331, which are respectively parts of the first and second side core portion 33a, 33b. The first end core portion 35a, the first middle core portion 31a and two first parts 331 are integrally formed. The respective first parts 331 extend in the X direction from both end parts in the Y direction of the first end core portion 35a toward the second parts 332. The first core 3a is E-shaped when viewed from the Z direction.

The second core 3b includes the second end core portion 35b, a second middle core portion 31b and the second parts 332, which are respectively the remaining parts of the second and second side core portion 33a, 33b. The second end core portion 35a, the second middle core portion 31a and two second parts 332 are integrally formed. The respective second parts 332 extend in the X direction from both end parts in the Y direction of the second end core portion 35b toward the first parts 331. The second core 3b is E-shaped when viewed from the Z direction.

A relationship of a relative magnetic permeability of the first end core portion 35a and that of the second end core portion 35b is similar to that of the first embodiment. That is, a relative magnetic permeability of the second end core portion 35b is larger than that of the first end core portion 35a. A sensor 6 is arranged on the side of the second end core portion 35b as in the first embodiment.

### Functions and Effects of Second Embodiment

The reactor 1b of the second embodiment can reduce the influence of a leakage magnetic flux on the sensor 6, similarly to the reactor 1a of the first embodiment.

### Third Embodiment

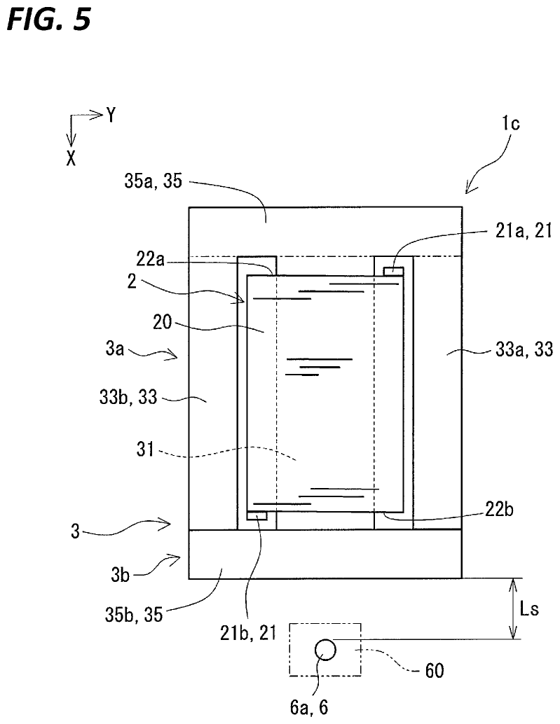

A reactor 1c of a third embodiment is described with reference to FIG. 5. The reactor 1c of the third embodiment differs from the reactor 1a of the first embodiment in that a magnetic core 3 is of an E-I type. The following description is centered on points of difference from the first embodiment. Components similar to those of the first embodiment are denoted by the same reference signs and not described. The resin molded member 4 described in the first embodiment is not shown in FIG. 5.

### <Magnetic Core>

The magnetic core 3 is configured by combining a first core 3a and a second core 3b in the X direction as in the first embodiment. The magnetic core 3 has an θ shape when viewed from the Z direction as shown in FIG. 5. In the third embodiment, a middle core portion 31 is not divided in the X direction unlike in the first embodiment.

The first core 3a includes a first end core portion 35a, the entire middle core portion 31, an entire first side core portion 33a and an entire second side core portion 33b. The first end core portion 35a, the middle core portion 31, the first side core portion 33a and the second side core portion 33b are integrally formed. The middle core portion 31 extends in the X direction from a middle part in the Y direction of the first end core portion 35a toward the second end core portion 35b. An end surface of the middle core portion 31 may or may not be in contact with the second end core portion 35b. In this embodiment, the end surface of the middle core portion 31 is in contact with the second end core portion 35b. If the end surface of the middle core portion 31 is not in contact with the second end core portion 35b, a gap portion is formed between the middle core portion 31 and the second end core portion 35b. The first core 3a is E-shaped when viewed from the Z direction.

The second core 3b includes only the second end core portion 35b. The second core 3b does not include the middle core portion 31, the first side core portion 33a and the second side core portion 33b. The second core 3b is I-shaped when viewed from the Z direction.

A relationship of a relative magnetic permeability of the first end core portion 35a and that of the second end core portion 35b is similar to that of the first embodiment. That is, the relative magnetic permeability of the second end core portion 35b is larger than that of the first end core portion 35a. Further, a sensor 6 is arranged on the side of the second end core portion 35b as in the first embodiment.

### Functions and Effects of Third Embodiment

The reactor 1c of the third embodiment can reduce the influence of a leakage magnetic flux on the sensor 6, similarly to the reactor 1a of the first embodiment.

### First Modification

In the case of mounting a temperature sensor as the sensor 6 in the reactors 1a, 1b and 1c of the first to third embodiments described above, the temperature sensor may be fixed to the second end core portion 35b of the second core 3b. The temperature sensor may be, for example, fixed to the upper surface of the second end core portion 35b. By fixing the temperature sensor to the second end core portion 35b, the influence of a leakage magnetic flux on the temperature sensor is reduced as compared to the case where the temperature sensor is fixed to the first end core portion 35a of the first core 3a. In the case of fixing the temperature sensor to the second end core portion 35b, a temperature of the second end core portion 35b can be measured by the temperature sensor. The temperature sensor can be fixed to the second end core portion 35b, for example, by an adhesive, an adhesive tape or solder.

### Fourth Embodiment

### [Converter, Power Conversion Device]

The reactors of the first to third embodiments can be utilized for applications satisfying the following energizing conditions. The energizing conditions include, for example, a maximum direct current of about 100 A or more and 1000 A or less, an average voltage of about 100 V or more and 1000 V or less and a use frequency of about 5 kHz or more and 100 kHz or less. The reactors 1a, 1b and 1c of the first to third embodiments can be typically used as a constituent component of a converter to be installed in a vehicle such as an electric vehicle or a hybrid vehicle or as a constituent component of a power conversion device provided with this converter.

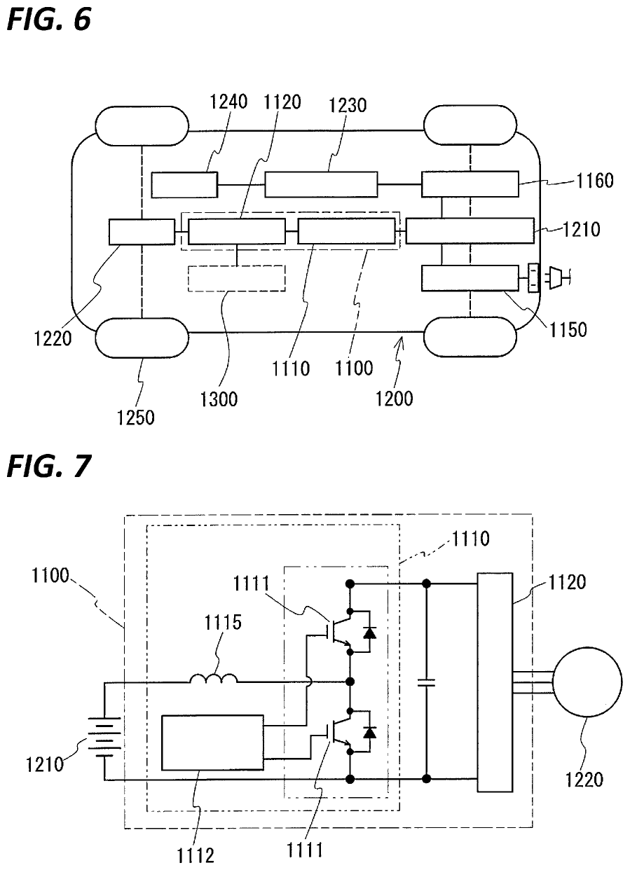

A vehicle 1200 such as a hybrid vehicle or an electric vehicle is, as shown in FIG. 6, provided with a main battery 1210, a power conversion device 1100 connected to the main body 1210 and a motor 1220 used for travel by being driven by power supplied from the main body 1210. The motor 1220 is, typically, a three-phase alternating current motor. The motor 1220 drives wheels 1250 during travel and functions as a generator during regeneration. In the case of a hybrid vehicle, the vehicle 1200 includes an engine 1300 in addition to the motor 1220. FIG. 6 shows an inlet as a charging point of the vehicle 1200, but the vehicle 1200 can include a plug.

The power conversion device 1100 includes a converter 1110 to be connected to the main battery 1210 and an inverter 1120 connected to the converter 1110 for the mutual conversion of a direct current and an alternating current. The converter 1110 shown in this example steps up an input voltage of the main battery 1210 of about 200 V or more and 300 V or less to about 400 V or more and 700 V or less and supplies the stepped-up voltage to the inverter 1120 during the travel of the vehicle 1200. The converter 1110 steps down an input voltage output from the motor 1220 via the inverter 1120 to a direct-current voltage suitable for the main battery 1210 and charges the main battery 1210 with the direct-current voltage during regeneration. The input voltage is a direct-current voltage. The inverter 1120 converts the direct current stepped up by the converter 1110 into a predetermined alternating current and supplies the converted current to the motor 1220 during the travel of the vehicle 1200 and converts an alternating current output from the motor 1220 into a direct current and outputs the direct current to the converter 1110 during regeneration.

The converter 1110 includes a plurality of switching elements 1111, a drive circuit 1112 for controlling the operation of the switching elements 1111 and a reactor 1115 as shown in FIG. 7 and converts an input voltage by being repeatedly turned on and off. The conversion of the input voltage means voltage step-up and -down here. A power device such as a field effect transistor or an insulated gate bipolar transistor is used as the switching element 1111. The reactor 1115 has a function of smoothing a change of a current when the current is increased or decreased by a switching operation, using a property of a coil to hinder a change of a current flowing into a circuit. Any one of the reactors of the first to third embodiments is provided as the reactor 1115. By including the reactor of any one of the first to third embodiments, physical quantities of the reactor are easily precisely measured by sensors.

Besides the converter 1110, the vehicle 1200 is provided with a power supply device converter 1150 connected to the main battery 1210 and an auxiliary power supply converter 1160 connected to a sub-battery 1230 and the main battery 1210 serving as power sources of auxiliary devices 1240 and configured to convert a high voltage of the main battery 1210 into a low voltage. The converter 1110 typically performs DC-DC conversion, but the power supply device converter 1150 and the auxiliary power supply converter 1160 perform AC-DC conversion. The power supply device converter 1150 may perform DC-DC conversion. Reactors configured similarly to any one of the reactors of the first to third embodiments and appropriately changed in size, shape and the like can be used as reactors of the power supply device converter 1150 and the auxiliary power supply converter 1160. Further, any one of the reactors of the first to third embodiments can also be used as a converter for converting input power and only stepping up a voltage or only stepping down a voltage.

### Test Example 1

A density distribution of a magnetic flux leaking from the magnetic core 3 during the operation of the reactor 1a was examined for the reactor 1a of the first embodiment.

In Text Example 1, a magnetic flux density distribution on the side of the second end core portion 35b and a magnetic flux density distribution on the side of the first end core portion 35a were respectively analyzed by CAE (Computer Aided Engineering). An analysis of the magnetic flux density distribution on the side of the second end core portion 35b is Analysis Example 1. An analysis of the magnetic flux density distribution on the side of the first end core portion 35a is Analysis Example 2. JMAG-Designer 19.0 produced by JSOL, which is a commercially available electromagnetic field analysis software, was used to analyze the magnetic flux density distributions. In Test Example 1, the configuration of the magnetic core 3 was set as follows.
Relative magnetic permeability of the first core: 25
Relative magnetic permeability of the second core: 200
Material of the first core: compact of composite material
Material of second core: powder compact

The following first operation conditions were set as operation conditions of the reactor 1a.
Input voltage: 200 V
Post-boosting voltage: 400 V
Switching frequency: 20 kHz
Superimposed current: 100 A

### Analysis Example 1

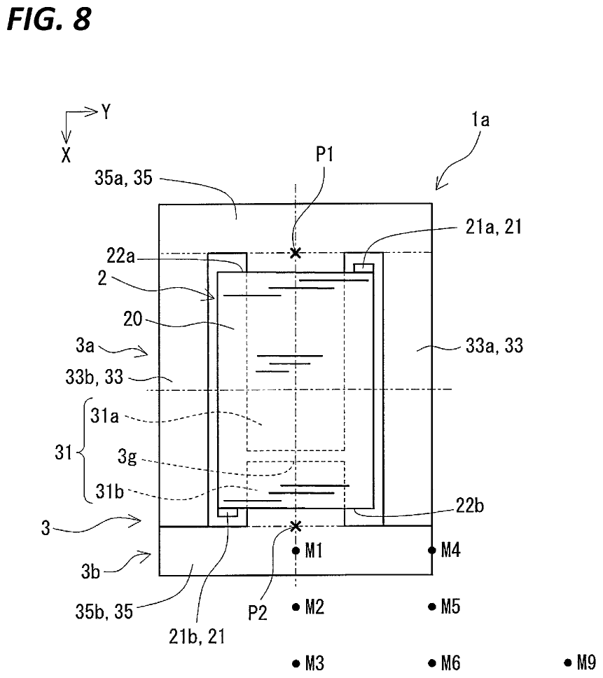

With reference to FIG. 8, Analysis Example 1 of the magnetic flux density distribution on the side of the second end core portion 35b is described. In Analysis Example 1, a Z-direction component of the magnetic flux density at each of nine measurement points M1 to M9 shown in FIG. 8 was obtained. Here, the position of each measurement point is represented by three-dimensional coordinates based on a reference point P2 of the second end core portion 35b. An X-coordinate of the reference point P2 is located on a boundary between the second end core portion 35b and the middle core portion 31. That is, the X-coordinate of the reference point P2 is located on a plane parallel to the surface of the second end core portion 35b facing the second end surface 22b of the winding portion 20. A Y-coordinate of the reference point P2 is located on an axis passing through a center of the middle core portion 31. A Z-coordinate of the reference point P2 is located on the upper surface of the second end core portion 35b. The three-dimensional coordinates of the reference point P2 of the second core 3b are set as an origin (0, 0, 0). In the X direction, a direction from the reference point P2 toward the second end core portion 35b is a positive direction of the X-coordinate. In the Y direction, a direction from the reference point P2 toward the side core portion 33 is a positive direction of the Y-coordinate. In the Z direction, an upward direction from the reference point P2 is a positive direction of the Z-coordinate. This upward direction is a direction toward a side forward of the plane of FIG. 8. The X-, Y- and Z-coordinates of each measurement point are shown in Table 1. A shortest distance Lm from the second end core portion 35b to each measurement point is also shown in Table 1.

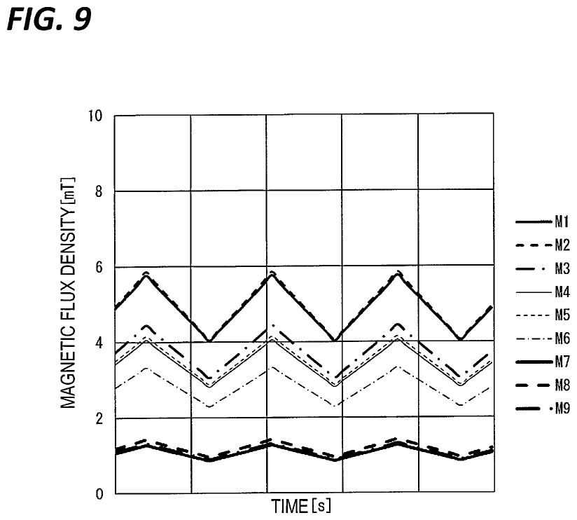

The maximum value Bmax of the magnetic flux density and the change width ΔB of the magnetic flux density at each of the measurement points M1 to M9 are shown in Table 2. Further, a temporal transition of the magnetic flux density at each measurement point is shown in FIG. 9. In a graph of FIG. 9, a horizontal axis represents time(s) and a vertical axis represents the magnetic flux density (mT). In the graph of FIG. 9, a value of the magnetic flux density at the measurement point M1 is represented by a solid line. A value of the magnetic flux density at the measurement point M2 is represented by a broken line. A value of the magnetic flux density at the measurement point M3 is represented by a one-dot chain line. A value of the magnetic flux density at the measurement point M4 is represented by a thin solid line. A value of the magnetic flux density at the measurement point M5 is represented by a thin broken line. A value of the magnetic flux density at the measurement point M6 is represented by a thin one-dot chain line. A value of the magnetic flux density at the measurement point M7 is represented by a thick solid line. A value of the magnetic flux density at the measurement point M8 is represented by a thick broken line. A value of the magnetic flux density at the measurement point M9 is represented by a thick one-dot chain line.

TABLE 1

| | X- | Y- | Z- | |
|---|---|---|---|---|
| Measurement | Coordinate | Coordinate | Coordinate | Distance |
| Point | (mm) | (mm) | (mm) | Lm (mm) |
| M1 | 5 | 0 | 40 | 40 |
| M2 | 20 | 0 | 40 | 45 |
| M3 | 35 | 0 | 40 | 53 |
| M4 | 5 | 40 | 40 | 57 |
| M5 | 20 | 40 | 40 | 60 |
| M6 | 35 | 40 | 40 | 67 |
| M7 | 5 | 80 | 40 | 90 |
| M8 | 20 | 80 | 40 | 92 |
| M9 | 35 | 80 | 40 | 96 |

TABLE 2

| | M1 | M2 | M3 | M4 | M5 | M6 | M7 | M8 | M9 |
|---|---|---|---|---|---|---|---|---|---|
| Bmax (mT) | 5.76 | 5.86 | 4.44 | 4.05 | 4.14 | 3.32 | 1.28 | 1.42 | 1.32 |
| ΔB (mT) | 1.73 | 1.79 | 1.39 | 1.24 | 1.27 | 1.03 | 0.41 | 0.46 | 043 |

### Analysis Example 2

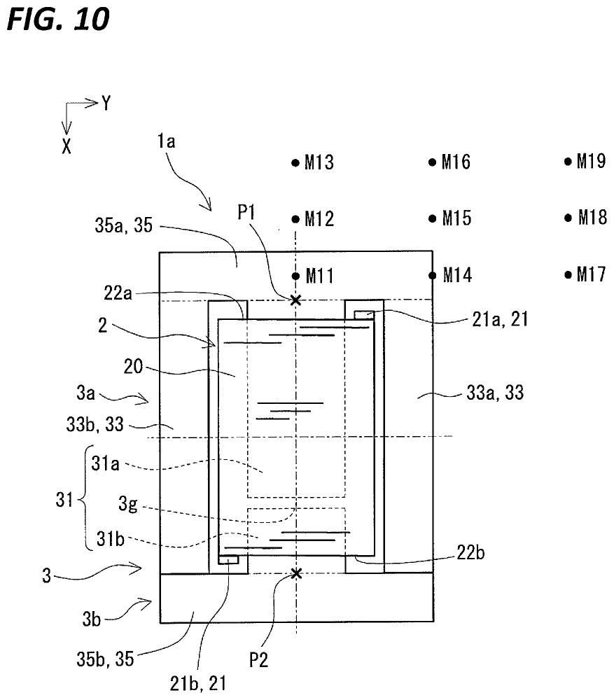

With reference to FIG. 10, Analysis Example 2 of the magnetic flux density distribution on the side of the second end core portion 35b is described. In Analysis Example 2, a Z-direction component of the magnetic flux density at each of nine measurement points M11 to M19 shown in FIG. 10 was obtained. Here, the position of each measurement point is represented by three-dimensional coordinates based on a reference point P1 of the first end core portion 35a. An X-coordinate of the reference point P1 is located on a boundary between the first end core portion 35a and the middle core portion 31. That is, the X-coordinate of the reference point P1 is located on a plane parallel to the surface of the first end core portion 35a facing the first end surface 22a of the winding portion 20. A Y-coordinate of the reference point P1 is located on an axis passing through the center of the middle core portion 31. A Z-coordinate of the reference point P1 is located on the upper surface of the first end core portion 35a. The three-dimensional coordinates of the reference point P1 of the first core 3a are set as an origin (0, 0, 0). In the X direction, a direction from the reference point P1 toward the first end core portion 35a is a positive direction of the X-coordinate. In the Y direction, a direction from the reference point P1 toward the side core portion 33 is a positive direction of the Y-coordinate. In the Z direction, an upward direction from the reference point P1 is a positive direction of the Z-coordinate. This upward direction is a direction toward a side forward of the plane of FIG. 10. The X-, Y- and Z-coordinates of each measurement point are shown in Table 3. A shortest distance Lm from the first end core portion 35a to each measurement point is also shown in Table 3.

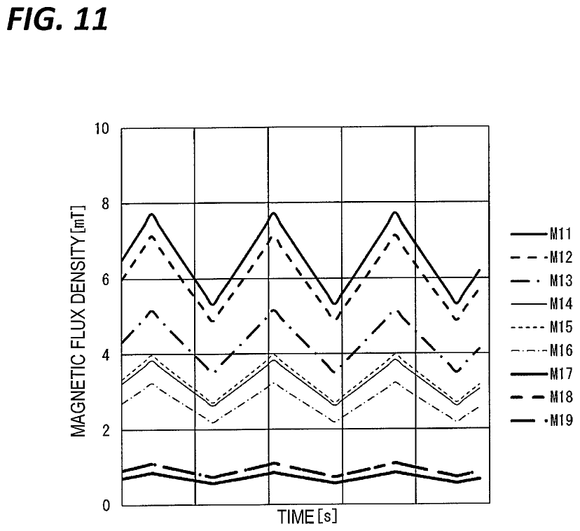

The maximum value Bmax of the magnetic flux density and the change width ΔB of the magnetic flux density at each of the measurement points M11 to M19 are shown in Table 4. Further, a temporal transition of the magnetic flux density at each measurement point is shown in FIG. 11. In a graph of FIG. 11, a horizontal axis represents time(s) and a vertical axis represents the magnetic flux density (mT). In the graph of FIG. 11, a value of the magnetic flux density at the measurement point M11 is represented by a solid line. A value of the magnetic flux density at the measurement point M12 is represented by a broken line. A value of the magnetic flux density at the measurement point M13 is represented by a one-dot chain line. A value of the magnetic flux density at the measurement point M14 is represented by a thin solid line. A value of the magnetic flux density at the measurement point M15 is represented by a thin broken line. A value of the magnetic flux density at the measurement point M16 is represented by a thin one-dot chain line. A value of the magnetic flux density at the measurement point M17 is represented by a thick solid line. A value of the magnetic flux density at the measurement point M18 is represented by a thick broken line. A value of the magnetic flux density at the measurement point M19 is represented by a thick one-dot chain line.

TABLE 3

| | X- | Y- | Z- | |
|---|---|---|---|---|
| M1easurement | Coordinate | Coordinate | Coordinate | Distance |
| Point | (mm) | (mm) | (mm) | Lm (mm) |
| M11 | 5 | 0 | 40 | 40 |
| M12 | 20 | 0 | 40 | 45 |
| M13 | 35 | 0 | 40 | 53 |
| M14 | 5 | 40 | 40 | 57 |
| M15 | 20 | 40 | 40 | 60 |
| M16 | 35 | 40 | 40 | 67 |
| M17 | 5 | 80 | 40 | 90 |
| M18 | 20 | 80 | 40 | 92 |
| M19 | 35 | 80 | 40 | 96 |

TABLE 4

| | M11 | M12 | M13 | M14 | M15 | M16 | M17 | M18 | M19 |
|---|---|---|---|---|---|---|---|---|---|
| Bmax (mT) | 7.72 | 7.13 | 5.15 | 3.83 | 3.97 | 3.23 | 0.85 | 1.10 | 1.10 |
| ΔB (mT) | 2.41 | 2.25 | 1.65 | 1.21 | 1.27 | 1.04 | 0.28 | 0.36 | 0.36 |

As shown in Table 2 of Analysis Example 1, the maximum value Bmax at each of the measurement points M1 to M3 is larger than the maximum value Bmax at each of the measurement points M4 to M6. Further, as shown in Table 4 of Analysis Example 2, the maximum value Bmax at each of the measurement points M11 to M13 is larger than the maximum value Bmax at each of the measurement points M14 to M16. From this result, it is understood that more magnetic flux leaks in the region on the extension of the middle core portion 31 than at positions deviated from the region on the extension in both the first and second end core portions 35a, 35b.

As shown in Table 2 of Analysis Example 1, a maximum of the maximum values Bmax at all the measurement points M1 to M9 is 5.86 (mT) at the measurement point M2. Further, a maximum value of the change widths ΔB at all the measurement points is 1.79 (mT) at the measurement point M2. As shown in Table 4 of Analysis Example 2, a maximum of the maximum values Bmax at all the measurement points M11 to M19 is 7.72 (mT) at the measurement point M11. Further, a maximum value of the change widths ΔB at all the measurement points is 2.41 (mT) at the measurement point M11. Thus, the maximum of the maximum values Bmax on the side of the second end core portion 35b is reduced by about 24% as compared to the maximum of the maximum values Bmax on the first end core portion 35a. Further, the maximum value of ΔB on the side of the second end core portion 35b is reduced by about 26% as compared to the maximum value of ΔB on the side of the first end core portion 35a. From this result, it is understood that, in the case of arranging the sensor on the side of the second end core portion 35b, the influence of a leakage magnetic flux on the sensor can be reduced as compared to the case of arranging the sensor on the side of the first end core portion 35a.

In Analysis Example 1, the change widths ΔB at all the measurement points are 2.0 mT or less and the maximum of the maximum values Bmax is 6.0 mT or less. Accordingly, the sensor is hardly affected by the leakage magnetic flux even if the sensor is arranged at a position near the second end core portion 35b like the measurement points M1, M2. It is possible to arrange the sensor at a position within 50 mm, particularly 45 mm from the second end core portion 35b. In the case of arranging the sensor on the side of the second end core portion 35b, the sensor can be arranged close to the reactor 1a. Thus, a degree of freedom in laying out the sensor is high. In contrary, in Analysis Example 2, the change widths ΔB at all the measurement points are more than 2.0 mT and the maximum of the maximum values Bmax is more than 6.0 mT at the measurement points M11, M12. Accordingly, the sensor is easily affected by the leakage magnetic flux if the sensor is arranged at a position near the first end core portion 35a like the measurement points M11, M12. In some cases, the sensor cannot be arranged at a position within 50 mm, particularly 45 mm from the first end core portion 35a. In the case of arranging the sensor on the side of the first end core portion 35a, it may not be possible to arrange the sensor close to the reactor 1a. Thus, a degree of freedom in laying out the sensor is low.

### Analysis Example 3

The magnetic flux densities in the case of moving the Z-coordinate of the measurement point M2 in Analysis Example 1 by +2 mm in the upward direction were obtained. The maximum values Bmax of the magnetic flux density and the change widths ΔB of the magnetic flux when the Z-coordinate of the measurement point M2 was moved from 0 mm to 16 mm are shown in Table 5. Further, the magnetic flux densities in the case of moving the Z-coordinate of the measurement point M11 in Analysis Example 2 by +2 mm in the upward direction were obtained. The maximum values Bmax of the magnetic flux density and the change widths ΔB of the magnetic flux when the Z-coordinate of the measurement point M11 was moved from 0 mm to 16 mm are shown in Table 6.

TABLE 5

| Movement | | | | | | | | | |
|---|---|---|---|---|---|---|---|---|---|
| Amount of Z- | 0 | +2 | +4 | +6 | +8 | +10 | +12 | +14 | +16 |
| Coordinate | mm | mm | mm | mm | mm | mm | mm | mm | mm |
| Bmax (mT) | 5.76 | 5.19 | 4.68 | 4.24 | 3.89 | 3.51 | 3.23 | 3.00 | 2.74 |
| ΔB (mT) | 1.73 | 1.58 | 1.40 | 1.27 | 1.17 | 1.05 | 0.97 | 0.90 | 0.82 |

TABLE 6

| Movement | | | | | | | | | |
|---|---|---|---|---|---|---|---|---|---|
| Amount of Z- | 0 | +2 | +4 | +6 | +8 | +10 | +12 | +14 | +16 |
| Coordinate | mm | mm | mm | mm | mm | mm | mm | mm | mm |
| Bmax (mT) | 7.27 | 7.03 | 6.41 | 5.77 | 5.27 | 4.74 | 4.31 | 4.00 | 3.71 |
| ΔB (mT) | 2.41 | 2.19 | 2.00 | 1.81 | 1.65 | 1.49 | 1.35 | 1.26 | 1.17 |

As shown in Table 5 and Table 6, it is understood that, in either case, the maximum value Bmax and the change width ΔB decrease as the movement amount of the Z-coordinate increases.

### Test Example 2

A leakage magnetic flux density when the reactor 1a of the first embodiment was actually operated was examined. In Test Example 2, a magnetic flux density distribution on the side of the second end core portion 35b and a magnetic flux density distribution on the side of the first end core portion 35a were measured using a Gauss meter by actually operating the reactor 1a. The configuration of the magnetic core 3 is set as in Test Example 1.

In Text Example 2, a Z-direction component of the magnetic flux density at each of the same nine measurement points M1 to M9 as in Analysis Example 1 of Test Example 1 was measured. The change width ΔB of the magnetic flux density at each of the measurement points M1 to M9 is shown in Table 7. Further, a Z-direction component of the magnetic flux density at each of the same nine measurement points M11 to M19 as in Analysis Example 2 of Test Example 1 was measured. The change width ΔB of the magnetic flux density at each of the measurement points M11 to M19 is shown in Table 8.

TABLE 7

| | M1 | M2 | M3 | M4 | M5 | M6 | M7 | M8 | M9 |
|---|---|---|---|---|---|---|---|---|---|
| ΔB (mT) | 1.8 | 1.5 | 1.5 | 1.1 | 1.2 | 0.9 | 0.4 | 0.7 | 0.6 |

TABLE 8

| | M11 | M12 | M13 | M14 | M15 | M16 | M17 | M18 | M19 |
|---|---|---|---|---|---|---|---|---|---|
| ΔB (mT) | 2.2 | 2.1 | 1.6 | 1.2 | 1.3 | 1.1 | 0.4 | 0.7 | 0.6 |

As shown in Table 7 and Table 8, it is understood that the maximum value of ΔB on the side of the second end core portion 35b was lower than that on the side of the first end core portion 35a like the analysis results shown in Table 2 and Table 4 of Test Example 1 even if the reactor 1a was actually operated.

### LIST OF REFERENCE NUMERALS

1a, 1b, 1c reactor
2 coil
   20 winding portion
   21 end portion, 21a first end portion, 21b second end portion
   22a first end surface, 22b second end surface
3 magnetic core
   3a first core, 3b second core
   31 middle core portion
      31a first middle core portion, 31b second middle core portion
   33 side core portion
      33a first side core portion, 33b second side core portion
      331 first part, 332 second part
   35 end core portion
      35a first end core portion, 35b second end core portion
   3g gap portion
4 resin molded member
6 sensor, 6a current sensor
60 circuit board
Ls distance
P1, P2 reference point
M1, M2, M3, M4, M5, M6, M7, M8, M9 measurement point
M11, M12, M13, M14, M15, M16, M17, M18, M19 measurement point
1100 power conversion device
   1110 converter, 1111 switching element, 1112 drive circuit
   1115 reactor, 1120 inverter
   1150 power supply device converter, 1160 auxiliary power supply converter
1200 vehicle
   1210 main battery, 1220 motor, 1230 sub-battery
   1240 auxiliary devices, 1250 wheel
   1300 engine

1. A reactor, comprising:
a coil;
a magnetic core; and
a sensor for measuring a physical quantity of the reactor,
the coil including a tubular winding portion,
the magnetic core including a first end core portion, a second end core portion, a middle core portion, a first side core portion and a second side core portion,
the middle core portion including a part to be arranged inside the winding portion,
the first side core portion and the second side core portion being arranged in parallel outside the winding portion to sandwich the middle core portion,
the middle core portion, the first side core portion and the second side core portion connecting the first end core portion and the second end core portion,
a relative magnetic permeability of the second end core portion being larger than that of the first end core portion, and
the sensor being arranged closer to the second end core portion than a center line between the first end core portion and the second end core portion.

2. The reactor of claim 1, wherein the relative magnetic permeability of the first end core portion is 5 or more and 50 or less.

3. The reactor of claim 2, wherein the relative magnetic permeability of the second end core portion is 100 or more and 500 or less.

4. The reactor of claim 1, wherein a distance from the second end core portion to the sensor is within 50 mm.

5. The reactor of claim 1, wherein:
the sensor is arranged at a position where a density change width of a magnetic field leaking from the magnetic core is 2.0 mT or less when the reactor is operated under first operation conditions, and
the first operation conditions include an input voltage of 200 V, a post-boosting voltage of 400 V, a switching frequency of 20 kHz and a superimposed current of 100 A.

6. The reactor of claim 5, wherein a maximum value of the magnetic field density is 6.0 mT or less.

7. The reactor of claim 5, wherein the sensor is arranged in a region overlapping the second end core portion in a plan view of the reactor.

8. The reactor of claim 5, wherein the sensor is arranged in a region on an extension of the middle core portion in a plan view of the reactor.

9. The reactor of claim 1, comprising a circuit board for controlling a current flowing in the coil, wherein:
the sensor is a current sensor, and
the current sensor is provided on the circuit board.

10. The reactor of claim 1, wherein:
the sensor is a temperature sensor, and
the temperature sensor is fixed to the second end core portion.

11. The reactor of claim 1, wherein:
the first end core portion is constituted by a compact of a composite material in which a soft magnetic powder is dispersed in a resin, and
the second end core portion is constituted by a powder compact of a raw powder containing a soft magnetic powder.

12. A converter, comprising the reactor of claim 1.

13. A power conversion device, comprising the converter of claim 12.
